(19) United States
(12) Patent Application Publication
(10) Pub. No.: US 2026/0152992 A1
(43) Pub. Date: Jun. 4, 2026

(54) ECOLOGICAL DOOR BODY

(71) Applicant: Guangdong OPK Smart Home Technology Co., Ltd., Zhongshan (CN)

(72) Inventor: Jiangde Xu, Zhongshan (CN)

(21) Appl. No.: 19/460,282

(22) Filed: Jan. 26, 2026

Related U.S. Application Data
(63) Continuation of application No. PCT/CN2024/100382, filed on Jun. 20, 2024.

(30) Foreign Application Priority Data
Aug. 21, 2023 (CN) 202322252454.5

(51) Int. Cl. E06B 3/72; E06B 3/968; E06B 3/263

(52) U.S. Cl. CPC E06B 3/725; E06B 3/9681; E06B 2003/26309

(57) ABSTRACT

Disclosed is an ecological door body, including: two side frame skeletons, the two side frame skeletons are arranged opposite to each other; a door leaf panel, the door leaf panel is arranged on the two side frame skeletons; a guide cross frame, the guide cross frame is fixedly connected to ends of the two side frame skeletons, and the guide cross frame clamps the door leaf panel, and two ends of the guide cross frame have openings configured to assemble functional components; and a side sealing frame, the side sealing frame is fixedly connected to the side frame skeleton, and clamps a side edge of the door leaf panel, and the side sealing frame is configured to seal the openings of the guide cross frame, thereby solving the problems of short service life, high noise, and safety hazards in existing ecological doors caused by a hinge structure.

### CROSS REFERENCE TO RELATED APPLICATIONS

The present disclosure is a Continuation Application of PCT Application No. PCT/CN2024/100382 filed on Jun. 20, 2024, which claims priority of Chinese Patent Application No. 202322252454.5 filed on Aug. 21, 2023, before CNIPA. All the above are hereby incorporated by reference in their entirety as part of the present disclosure.

### TECHNICAL FIELD

The present disclosure relates to the field of door bodies, and particularly relates to an ecological door body.

### BACKGROUND

An ecological door is a home furnishing product that, based on a natural foundation, utilizes natural conditions and artificial means to create a comfortable and healthy living environment. The concept of an "ecological door" is derived from "ecological home furnishing." The key aspects of ecological home furnishing are environmental protection and health, which exceed the standards of "green home furnishing." It not only involves hardware requirements but also encompasses humanistic needs, emphasizing the harmonious coexistence between humans and nature. An "ecological door" should be an element of "ecological home furnishing." In this sense, ecological doors should emphasize ecology, highlight the harmony between humans and nature, and should be a humanistic product. Compared to commonly used solid wood doors and composite doors, ecological doors should possess more societal connotations.

Existing ecological doors include a door leaf, which includes a door leaf frame, a door core, and two door leaf panels. The door core is embedded in the door leaf frame, and the two door leaf panels are respectively arranged on the two larger-area sides of the door core. A door frame is provided at the top and the two smaller-area sides of the door leaf. The door frame is equipped with door frame components, and one side of the door leaf is rotatably connected to the door frame via hinges.

Since the door leaf of the existing ecological door described above is fixed via hinges, meaning that the existing ecological door is subjected to force on one side, the door leaf frame, door core, and other door body components are required to be lightweight and possess high strength. However, the force distribution in the hinge fixation method is always unbalanced, imposing high weight requirements on the door body. Additionally, hinges are prone to significant wear, leading to a short service life, as well as potential noise and safety hazards.

### SUMMARY

To overcome at least one of the defects in the prior art described above, the present disclosure provides an ecological door body, solving the problems of short service life, high noise, and safety hazards in existing ecological doors caused by hinge structures.

The technical solution adopted by the present disclosure to address the problem is:

An ecological door body includes:

two side frame skeletons, where the two side frame skeletons are arranged opposite to each other;

a door leaf panel, where the door leaf panel is arranged on the two side frame skeletons;

a guide cross frame, where the guide cross frame is fixedly connected to ends of the two side frame skeletons, and the guide cross frame clamps the door leaf panel, and two ends of the guide cross frame have openings configured to assemble functional components; and

a side sealing frame, where the side sealing frame is fixedly connected to the side frame skeleton, and clamps a side edge of the door leaf panel, and the side sealing frame is configured to seal the openings of the guide cross frame.

In some implementations of the present disclosure, a side wall of the guide cross frame is formed with a panel clamping groove configured to clamp the door leaf panel, and the panel clamping groove extends along a length direction of the guide cross frame.

In some implementations of the present disclosure, an assembly guide groove configured to install a sliding component is arranged inside the guide cross frame.

In some implementations of the present disclosure, a linkage guide groove is formed between a groove wall of the assembly guide groove and the side wall of the guide cross frame, and the linkage guide groove is configured to install a linkage component.

In some implementations of the present disclosure, the ecological door body further includes a sound-absorbing and shock-absorbing member, where the side frame skeleton is provided with a shock-absorbing fixing groove configured to fix the sound-absorbing and shock-absorbing member, and the sound-absorbing and shock-absorbing member acts between the side sealing frame and the side frame skeleton.

In some implementations of the present disclosure, the side frame skeleton is provided with a skeleton snapping portion, and the side sealing frame is provided with a frame snapping portion configured to clamp the skeleton snapping portion.

In some implementations of the present disclosure, the side sealing frame is provided with a clamping edge protrusion, the clamping edge protrusion extends along a length direction of the side sealing frame, and the clamping edge protrusion cooperates with the side frame skeleton to clamp the door leaf panel.

In some implementations of the present disclosure, a side of the clamping edge protrusion close to the door leaf panel is provided with a pressing protrusion, and the pressing protrusion abuts against and contacts the door leaf panel.

In some implementations of the present disclosure, the ecological door body further includes a door core plate member, where the door core plate member is located between the two side frame skeletons, and the door core plate member is connected into a door core clamping groove of the side frame skeleton.

In some implementations of the present disclosure, the door core plate member is adhesively connected to the door leaf panel.

In summary, the ecological door body provided in the present disclosure achieves the following technical effects:

By means of the cooperation among the guide cross frame, the door leaf panel, the side sealing frame, and the two side frame skeletons, the existing ecological door’s method of bearing force and opening/closing via hinges is replaced. This enables the ecological door to be equipped with functional components, achieving the purposes of sliding opening/closing and balanced force distribution for the ecological door, thereby improving the load-bearing capacity of the ecological door. The problems of short service life, high noise, and safety hazards in existing ecological doors caused by a hinge structure are solved. Moreover, the structure of the ecological door body is stable and compactly assembled, which is beneficial for production and assembly.

### BRIEF DESCRIPTION OF THE DRAWINGS

FIG. 1 is a schematic view of the overall structure of an ecological door body according to the present application;

FIG. 2 is a first schematic assembly view of an ecological door body according to the present application;

FIG. 3 is a second schematic assembly view of an ecological door body according to the present application;

FIG. 4 is a schematic structural view of a side frame skeleton according to the present application;

FIG. 5 is a schematic structural view of a guide cross frame according to the present application;

FIG. 6 is a schematic structural view of a side sealing frame according to the present application;

FIG. 7 is a schematic structural view of a sound-absorbing and shock-absorbing member according to the present application.

Reference Numerals: 1, side frame skeleton; 11, anti-slip protrusion; 12, door core clamping groove; 13, skeleton snapping portion; 14, frame insertion groove; 15, shock-absorbing fixing groove; 2, door leaf panel; 3, guide cross frame; 31, panel clamping groove; 32, assembly guide groove; 33, guide cavity; 34, linkage guide groove; 4, side sealing frame; 41, frame snapping portion; 42, clamping edge protrusion; 43, pressing protrusion; 5, inner core space; 6, sound-absorbing and shock-absorbing member.

### DETAILED DESCRIPTION

For a better understanding and implementation, the technical solutions in the embodiments of the present disclosure are clearly and completely described below in conjunction with the attached drawings of the present disclosure.

In the description of the present disclosure, it is to be noted that the terms "up", "down", "front", "back", "left", "right", "vertical", "horizontal", "top", "bottom", "inside", "outside", and other orientation or position relationships are based on the orientation or position relationships shown in the attached drawings. It is only intended to facilitate description of the present disclosure and simplify description, but not to indicate or imply that the referred device or element has a specific orientation, or is constructed and operated in a specific orientation. Therefore, they should not be construed as a limitation of the present disclosure.

Unless otherwise defined, all terms including technical and scientific terms used herein have the same meaning as commonly understood by those skilled in the art to which the present disclosure belongs. The terms used herein in the specification of the present disclosure are used only to describe specific embodiments and are not intended as a limitation of the disclosure.

The present disclosure aims to apply functional components (the functional components include a sliding component and a linkage component) to the structure of an ecological door, in order to improve the problems of weight limitation, short service life, high noise, and safety hazards in existing ecological doors. The sliding component is employed to bear the overall weight of the ecological door and guide the ecological door to open and close by sliding. The linkage component is used for force transmission and linkage among multiple ecological doors. The functional components are not shown in the accompanying drawings, since the functional components belong to prior art and can be adjusted and changed according to design and selection.

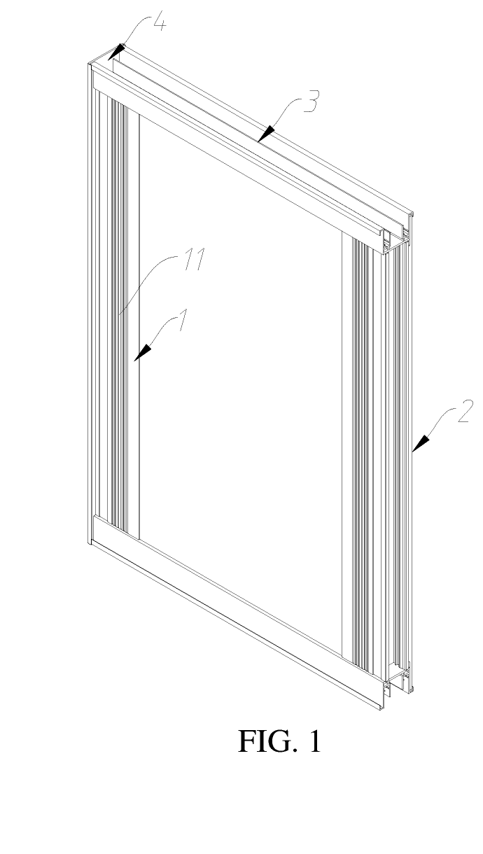

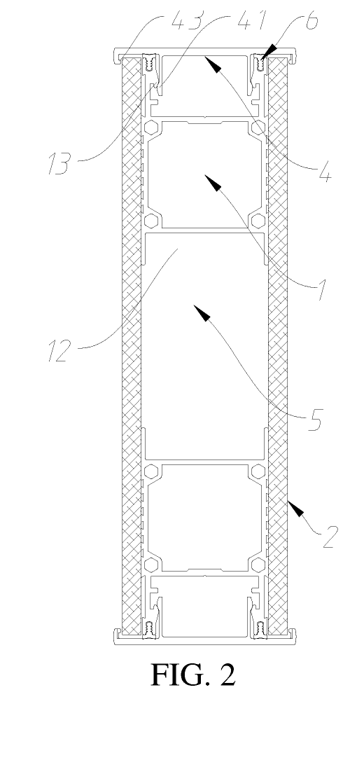

Specifically, referring to FIGS. 1 and 2, the present disclosure discloses an ecological door body, including:

two side frame skeletons 1, where the two side frame skeletons 1 are arranged opposite to each other;

a door leaf panel 2, where the door leaf panel 2 is arranged on the two side frame skeletons 1;

a guide cross frame 3, where the guide cross frame 3 is fixedly connected to ends of the two side frame skeletons 1, and the guide cross frame 3 clamps the door leaf panel 2, and two ends of the guide cross frame 3 have openings configured to assemble the functional components. Through the openings of the guide cross frame 3, not only can the functional components be easily and conveniently assembled into the interior of the guide cross frame 3, but also the installation of the functional components is made more flexible, facilitating easier adjustments during the assembly process of the ecological door body;

a side sealing frame 4, where the side sealing frame 4 is fixedly connected to the side frame skeleton 1, and clamps a side edge of the door leaf panel 2, and the side sealing frame 4 is configured to seal the openings of the guide cross frame 3.

In this embodiment, the door leaf panel 2 may be a polymer ecological board, or other ecological boards, or aluminum-wood composite boards, and the like. It is preferably configured with two door leaf panels 2, and the two door leaf panels 2 are arranged opposite to each other. A guide cavity 33 is provided inside the above-mentioned guide cross frame 3, and the functional components are all installed inside the guide cavity 33. It is also preferably configured with two guide cross frame 3, and the two guide cross frames 3 are arranged opposite to each other in a sliding manner. One guide cross frame 3 slides in an upper guide groove of a building body, and the other guide cross frame 3 slides in a lower guide groove of the building body, to ensure that the ecological door body can perform sliding motion very stably, thereby ensuring the smoothness and stability of the ecological door body during use.

During the assembly process of the ecological door body, first, one of the guide cross frames 3 is bolted to the two side frame skeletons 1. Then, the two door leaf panels 2 are abutted against and contacted with the two opposite sides of the two side frame skeletons 1, and both are clamped to the guide cross frame 3. Subsequently, the other guide cross frame 3 is bolted to the two side frame skeletons 1, ensuring that each door leaf panel 2 can be clamped and subjected to force evenly, thereby guaranteeing the stability of the assembly among the door leaf panels 2, the guide cross frames 3, and the side frame skeletons 1. Finally, the two side sealing frames 4 are used to seal the two opposite sides of the side frame skeletons 1. In this way, not only are the openings at both ends of the guide cross frame 3 sealed, making the guide cavity 33 of the guide cross frame 3 a relatively sealed space, preventing dust and objects from the outside of the guide cavity 33 from entering and accumulating inside the guide cavity 33, which poses hygiene risks, but it also avoids the functional components inside the guide cavity 33 being exposed through the end openings of the guide cross frame 3, which would cause aesthetic issues. At the same time, the side sealing frame 4 clamps and fixes the door leaf panel 2, ensuring that the door leaf panel 2 does not shift along the length direction of the guide cross frame 3 during the push-pull force application, achieving a fully constrained effect on the door leaf panel 2.

It should be noted that the above assembly method is provided only as a reference example and is not limited to the described method. The assembly method for the ecological door body may be adjusted according to the experience and habits of the assembler.

Furthermore, to prevent the door leaf panel 2 from shifting along the length direction of the guide cross frame 3 during push-pull force application, the outer side wall of the side frame skeleton 1 is also provided with anti-slip protrusions 11. The number of anti-slip protrusions 11 is preferably configured as multiple, with the multiple anti-slip protrusions 11 arranged in an array along the length direction of the guide cross frame 3, and each anti-slip protrusion 11 extends along the length direction of the side frame skeleton 1.

It should also be noted that the two guide cross frames 3, the two door leaf panels 2, and the two side frame skeletons 1 enclose an inner core space 5 configured to fix the door core plate member. The ecological door body further includes a door core plate member. The material selection for the door core plate member can be determined according to design requirements or structural design, and is not limited here. Furthermore, a door core clamping groove 12 is formed on a side of the side frame skeleton 1 close to the inner core space. Thus, during the assembly process of the ecological door body, the door core plate member can be pre-clamped into the door core clamping groove 12 of each side frame skeleton 1. On one hand, this allows the door core plate member to be preliminarily positioned between the two side frame skeletons 1, and the door core plate member is connected into the door core clamping groove 12 of the side frame skeleton 1, completing the initial assembly and fixation, thereby improving the convenience of assembling the ecological door body. On the other hand, it also ensures the compact assembly of the ecological door body, and the door core plate member is utilized to fill the inner core space 5, further enhancing the overall strength and sound insulation and noise reduction effects of the ecological door body.

Furthermore, by utilizing the wall thickness of the door core clamping groove 12, the door core plate member is adhesively connected to the door leaf panel 2, enhancing the structural strength of the ecological door body. At the same time, it may further prevent the door leaf panel 2 from sliding. It should be noted that the term "adhesive connection" referred to here includes methods using adhesive bonding and adhesive tape bonding.

Further, to further improve the stability of the door core plate member in the ecological door body, the door core plate member can be fixedly connected to the guide cross frame 3 via several fasteners (such as bolts, screws, or studs).

Thus, when pushing the ecological door body, the user applies pressure with their hand on the door leaf panel 2 and uses friction to push the door leaf panel 2, thereby achieving the opening and closing of the ecological door body. In this process, the door leaf panel 2 is pressed against the anti-slip protrusions 11 on the outer side wall of the side frame skeleton 1. Under the action of the anti-slip protrusions 11, the friction between the door leaf panel 2 and the side frame skeleton 1 is greatly increased, effectively preventing the risk of displacement of the door leaf panel 2.

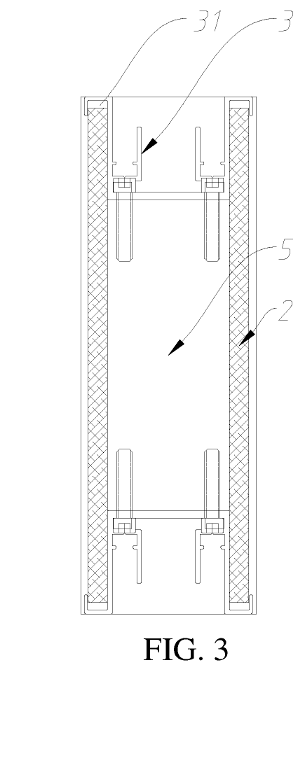

As a preferred implementation of this embodiment, specifically referring to FIGS. 3 and 5, the side wall of the guide cross frame 3 is formed with a panel clamping groove 31 configured to clamp the door leaf panel 2, and the panel clamping groove 31 extends along the length direction of the guide cross frame 3. The groove width of the panel clamping groove 31 is preferably matched with the thickness of the door leaf panel 2, although the groove width of the panel clamping groove 31 may also be larger than the thickness of the door leaf panel 2 within the assembly tolerance range.

As shown in FIG. 5, the two opposite side walls of the guide cross frame 3 near the opening extend in a direction perpendicular to the side walls to form first extension portions. Each first extension portion extends in the depth direction T of the guide cavity 33 to form a second extension portion. The first extension portion, the second extension portion, and the side wall of the guide cross frame 3 are integrally formed as the aforementioned panel clamping groove 31. The extension dimension of the second extension portion is determined based on aesthetic and structural design requirements, and is not limited here. In such an arrangement, the first extension portion, the second extension portion, and the guide cross frame 3 are integrally formed, ensuring the overall structural strength and aesthetic appearance of the guide cross frame 3.

As a further preferred implementation of this embodiment, specifically referring to FIG. 5, an assembly guide groove 32 configured to install a sliding component is provided inside the guide cross frame 3. That is, by utilizing the limiting effect of the assembly guide groove 32, not only is quick positioning of the sliding component during assembly achieved, improving the convenience and efficiency of assembling the sliding component with the ecological door body, but also, by constraining the sliding component within the assembly guide groove 32, when the sliding component is subjected to a force along the groove width direction of the assembly guide groove 32, the sliding component can abut against and act on the inner side wall of the assembly guide groove 32, thereby achieving the objective of stable assembly between the sliding component and the guide cross frame 3.

Preferably, the assembly guide groove 32 is arranged inside the guide cavity 33 of the guide cross frame 3 and located at a middle portion of the guide cavity 33, which is beneficial for ensuring force balance during the sliding of the ecological door body and also facilitates manufacturing the guide cross frame 3. The groove width of the assembly guide groove 32 is adapted to the width of the sliding component, or the groove width of the assembly guide groove 32 is larger than the width of the sliding component within the assembly tolerance range.

As a further preferred implementation of this embodiment, specifically referring to FIG. 5, a linkage guide groove 34 is formed between a groove wall of the assembly guide groove 32 and the side wall of the guide cross frame 3, and the linkage guide groove 34 is configured to install a linkage component.

Specifically, the groove length extension direction of the assembly guide groove 32 is consistent with the length direction of the guide cross frame 3, and the groove length extension direction of the linkage guide groove 34 is consistent with the groove length direction of the assembly guide groove 32. Therefore, the linkage component is constrained inside the linkage guide groove 34, ensuring that the linkage component can move linearly back and forth along the groove length extension direction of the linkage guide groove 34. In such an arrangement, the movement direction of the linkage component is consistent with that of the ecological door body, thereby ensuring that the movement direction of a linked door body adjacent to the ecological door body is consistent with the movement of the ecological door body, improving the accuracy and smoothness of the linkage transmission.

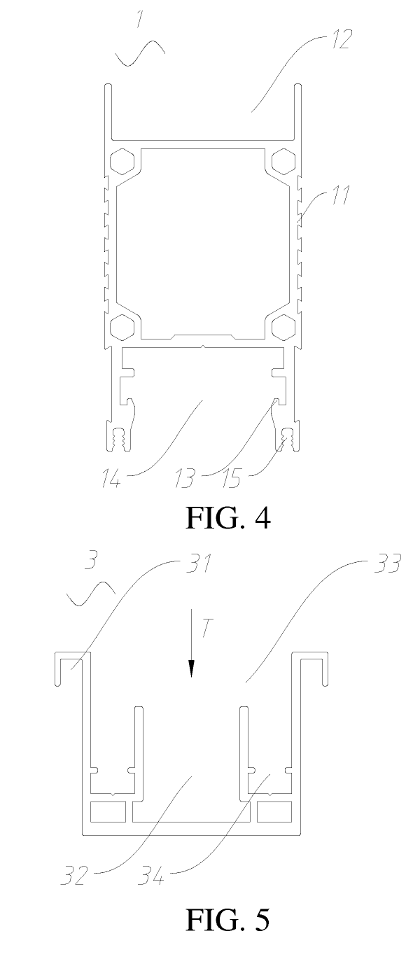

As a preferred implementation of this embodiment, specifically referring to FIGS. 2, 4, and 6, the side frame skeleton 1 is provided with a skeleton snapping portion 13, and the side sealing frame 4 is provided with a frame snapping portion 41 configured to clamp the skeleton snapping portion 13.

Specifically, a frame insertion groove 14 is provided on the side frame skeleton 1 near the side sealing frame 4. A convex structure is formed protruding from the inner side wall of the frame insertion groove 14, and this convex structure constitutes the skeleton snapping portion 13. Correspondingly, the side sealing frame 4 extends toward the interior of the frame insertion groove 14 with a cantilever hook structure, and this cantilever hook structure constitutes the frame snapping portion 41. When assembling the side sealing frame 4 to the side frame skeleton 1, the frame snapping portion 41 is inserted into the frame insertion groove 14 until the skeleton snapping portion 13 snaps onto the frame snapping portion 41, achieving the clamping purpose between the side frame skeleton 1 and the side sealing frame 4. This structure is simple, assembly is convenient, and it also facilitates subsequent disassembly, replacement, and maintenance of the ecological door body.

It should be noted that the aforementioned convex structure is not limited to be on the inner side wall of the frame insertion groove 14, and may also be on the outer side wall of the frame insertion groove 14. Additionally, the skeleton snapping portion 13 may also be a clamping groove structure, meaning that a clamping groove structure is recessed into the inner or outer side wall of the frame insertion groove 14. In such an arrangement, the clamping purpose between the side frame skeleton 1 and the side sealing frame 4 may also be achieved.

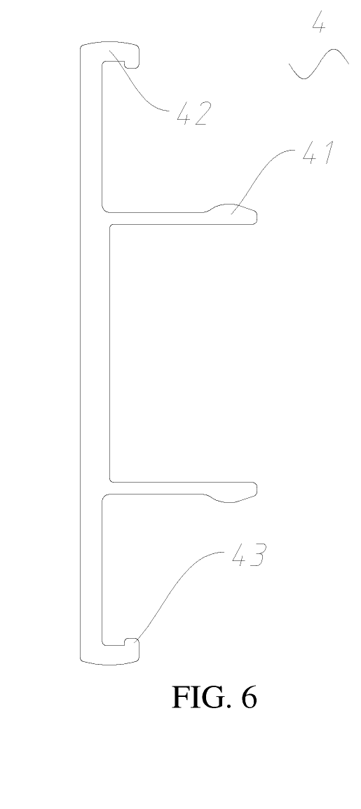

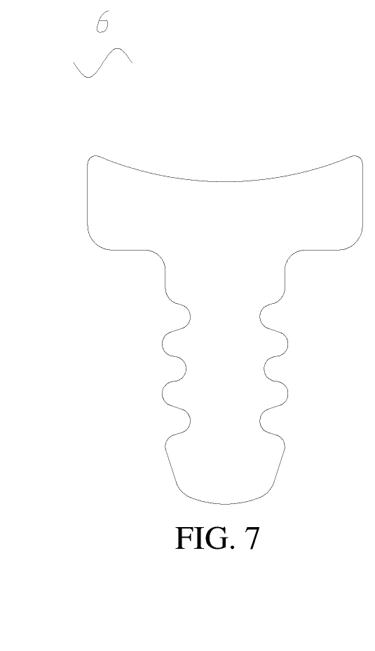

As a preferred implementation of this embodiment, specifically referring to FIGS. 2 and 6, the side sealing frame 4 has a clamping edge protrusion 42. The clamping edge protrusion 42 extends along the length direction of the side sealing frame 4, and the clamping edge protrusion 42 cooperates with the side frame skeleton 1 to clamp the door leaf panel 2.

It should be noted that the protrusion height of the clamping edge protrusion 42 is determined based on aesthetic and structural design requirements, and is not limited here.

As shown in FIG. 2, when the side sealing frame 4 is assembled to the side frame skeleton 1, the outer side wall of the side frame skeleton 1, the clamping edge protrusion 42 of the side sealing frame 4, and the main body of the frame form a groove structure. In such an arrangement, the door leaf panel 2 may be constrained inside the groove structure.

As a further preferred implementation of the present embodiment, specifically referring to FIGS. 2 and 6, a pressing protrusion 43 is provided on a side of the clamping edge protrusion 42 close to the door leaf panel 2, and the pressing protrusion 43 abuts against and contacts the door leaf panel 2. The pressing protrusion 43 preferably extends along the length direction of the side sealing frame 4, to ensure balanced force application between the pressing protrusion 43 and the door leaf panel 2.

On one hand, this ensures the compactness and stability of the assembly between the door leaf panel 2 and the side sealing frame 4. Moreover, it prevents direct large-area contact between the side sealing frame 4 and the door leaf panel 2 during the assembly process, which could cause wear issues, thereby protecting both the side sealing frame 4 and the door leaf panel 2. It also avoids difficulties in assembling the side sealing frame 4 due to frictional resistance generated by direct large-area contact between the side sealing frame 4 and the door leaf panel 2, ensuring the convenience of assembling the side sealing frame 4.

On the other hand, the pressing protrusion 43 compensates for any assembly gap between the door leaf panel 2 and the side sealing frame 4, effectively ensuring the overall aesthetic appearance of the ecological door body. It also prevents dust and debris (such as paper scraps) from accumulating in the assembly gap between the door leaf panel 2 and the side sealing frame 4.

With the above structure, the ecological door body achieves excellent structural strength, assembly compactness, and force stability, ensuring its operational stability during use. Typically, both the side sealing frame 4 and the side frame skeleton 1 are metal components, ensuring the structural strength and rigidity of the ecological door body. However, if the side sealing frame 4 becomes loose or during the assembly process, it may collide with the side frame skeleton 1, leading to noise issues from metal contact or collision.

Referring to FIG. 7, the ecological door body further includes a sound-absorbing and shock-absorbing member 6. Here, the sound-absorbing and shock-absorbing member 6 is made of non-metallic materials, such as plastic, rubber, or silicone. The side frame skeleton 1 is provided with a shock-absorbing fixing groove 15 configured to fix the sound-absorbing and shock-absorbing member 6. That is, the sound-absorbing and shock-absorbing member 6 is embedded inside the shock-absorbing fixing groove 15, and the sound-absorbing and shock-absorbing member 6 acts between the side sealing frame 4 and the side frame skeleton 1, forming a flexible connection between the side sealing frame 4 and the side frame skeleton 1.

Thus, when vibration or collision occurs during the use of the ecological door body, under the buffering effect of the sound-absorbing and shock-absorbing member 6, the vibrational force or impact force generated by the collision is quickly absorbed by the sound-absorbing and shock-absorbing member 6. As a result, no collision occurs between the side sealing frame 4 and the side frame skeleton 1, effectively eliminating the issue of vibration noise during the use of the ecological door body.

Furthermore, to prevent the sound-absorbing and shock-absorbing member 6 from easily detaching from the shock-absorbing fixing groove 15, an anti-detachment protrusion is provided on the end surface of the sound-absorbing and shock-absorbing member 6 configured for insertion into the shock-absorbing fixing groove 15 and/or on the inner side wall of the shock-absorbing fixing groove 15, ensuring stable assembly between the sound-absorbing and shock-absorbing member 6 and the side frame skeleton 1.

The technical means disclosed in the solution of the present disclosure are not limited to those disclosed in the embodiments mentioned above but also include technical solutions consisting of any combination of the above technical features. It should be noted that for those skilled in the art, multiple improvements and modifications may be made without departing from the principles of the present disclosure. These improvements and modifications are also considered to be within the scope of protection of the present disclosure.

What is claimed is:

1. An ecological door body, comprising:
two side frame skeletons, wherein the two side frame skeletons are arranged opposite to each other;
a door leaf panel, wherein the door leaf panel is arranged on the two side frame skeletons;
a guide cross frame, wherein the guide cross frame is fixedly connected to ends of the two side frame skeletons, and the guide cross frame clamps the door leaf panel, and two ends of the guide cross frame have openings configured to assemble functional components; and
a side sealing frame, wherein the side sealing frame is fixedly connected to the side frame skeleton, and clamps a side edge of the door leaf panel, and the side sealing frame is configured to seal the openings of the guide cross frame.

2. The ecological door body according to claim 1, wherein a side wall of the guide cross frame is formed with a panel clamping groove configured to clamp the door leaf panel, and the panel clamping groove extends along a length direction of the guide cross frame.

3. The ecological door body according to claim 1, wherein an assembly guide groove configured to install a sliding component is arranged inside the guide cross frame.

4. The ecological door body according to claim 2, wherein an assembly guide groove configured to install a sliding component is arranged inside the guide cross frame.

5. The ecological door body according to claim 3, wherein a linkage guide groove is formed between a groove wall of the assembly guide groove and a side wall of the guide cross frame, and the linkage guide groove is configured to install a linkage component.

6. The ecological door body according to claim 4, wherein a linkage guide groove is formed between a groove wall of the assembly guide groove and the side wall of the guide cross frame, and the linkage guide groove is configured to install a linkage component.

7. The ecological door body according to claim 1, further comprising a sound-absorbing and shock-absorbing member, wherein the side frame skeleton is provided with a shock-absorbing fixing groove configured to fix the sound-absorbing and shock-absorbing member, and the sound-absorbing and shock-absorbing member acts between the side sealing frame and the side frame skeleton.

8. The ecological door body according to claim 1, wherein the side frame skeleton is provided with a skeleton snapping portion, and the side sealing frame is provided with a frame snapping portion configured to clamp the skeleton snapping portion.

9. The ecological door body according to claim 7, wherein the side frame skeleton is provided with a skeleton snapping portion, and the side sealing frame is provided with a frame snapping portion configured to clamp the skeleton snapping portion.

10. The ecological door body according to claim 1, wherein the side sealing frame is provided with a clamping edge protrusion, the clamping edge protrusion extends along a length direction of the side sealing frame, and the clamping edge protrusion cooperates with the side frame skeleton to clamp the door leaf panel.

11. The ecological door body according to claim 7, wherein the side sealing frame is provided with a clamping edge protrusion, the clamping edge protrusion extends along a length direction of the side sealing frame, and the clamping edge protrusion cooperates with the side frame skeleton to clamp the door leaf panel.

12. The ecological door body according to claim 10, wherein a side of the clamping edge protrusion close to the door leaf panel is provided with a pressing protrusion, and the pressing protrusion abuts against and contacts the door leaf panel.

13. The ecological door body according to claim 11, wherein a side of the clamping edge protrusion close to the door leaf panel is provided with a pressing protrusion, and the pressing protrusion abuts against and contacts the door leaf panel.

14. The ecological door body according to claim 1, further comprising a door core plate member, wherein the door core plate member is located between the two side frame skeletons, and the door core plate member is connected into a door core clamping groove of the side frame skeleton.

15. The ecological door body according to claim 14, wherein the door core plate member is adhesively connected to the door leaf panel.
